(19) United States
(12) Patent Application Publication
(10) Pub. No.: US 2023/0258427 A1
(43) Pub. Date: Aug. 17, 2023

(54) HEAD RELATIVE WEAPON ORIENTATION VIA OPTICAL PROCESS

(71) Applicant: Cubic Corporation, San Diego, CA (US)

(72) Inventors: Keith William Doolittle, Orlando, FL (US); Lifan Hua, Orlando, FL (US); David Robert Simmons, Orlando, FL (US); Adam Robb Syme, Orlando, FL (US); Robyn Ann Yost, Orlando, FL (US); Peter Jonathan Martin, Orlando, FL (US); Carson Alan Brown, Orlando, FL (US); Michele Fleming, Orlando, FL (US); Vern Edgar Campbell, Orlando, FL (US)

(73) Assignee: Cubic Corporation, San Diego, CA (US)

(21) Appl. No.: 17/980,461

(22) Filed: Nov. 3, 2022

Related U.S. Application Data
(60) Provisional application No. 63/275,263, filed on Nov. 3, 2021.

(51) Int. Cl. F41A 33/00; G06T 7/73; G06F 3/01; G06T 19/00

(52) U.S. Cl. CPC F41A 33/00; G06T 7/74; G06F 3/012; G06T 19/006; G06T 2207/30204

(57) ABSTRACT

The present disclosure explains a system and method for determining a spatial orientation of a weapon in an augmented reality training environment. Fiducial markers are mounted on the weapon and two cameras are mounted on a user's head to capture spatial coordinates of the plurality of fiducial markers. The spatial coordinates of fiducial markers are processed to determine the spatial orientation of the weapon and a simulated discharging of the weapon. Augmented reality imagery is generated based on the spatial orientation and the detected movement. The augmented reality imagery corresponding to the spatial orientation and discharging of the weapon is rendered for the user with the head-mounted display.

This application claims the benefit of and is a non-provisional of U.S. Provisional Application Ser. No. U.S. 63/275,263 filed on Nov. 3, 2021, which is hereby expressly incorporated by reference in its entirety for all purposes. Simulated training environments.

This disclosure was supported by U.S. Government under an award by U.S. Army PEO STRI for Soldier/Squad Virtual Trainer Weapons Optimization OTA under Contract/Grant No. NSTXL OTA W900KK-18-9-0005 to W900KK-19-9-0012 for NSTXL Project Agreement No. NSTXL-TREX-19-0012a, which outlines certain rights in the disclosure given to the U.S. Government.

### BACKGROUND

This disclosure relates in general to an augmented reality system and, not by way of limitation, to train in a weapon simulating environment.

In weapon simulators, the weapon is tracked either externally via truss mounted cameras or with a weapon mounted device that may include accelerometers, gyros, and/or magnetometers. The weapon or game controller uses integral electronics to permit tracking of the simulated environment. These systems result in the six degrees of freedom (6-Dof) orientation and position of the weapon in a real-world coordinate system. As more and more trainers are using head mounted displays (HMDs) such as augmented reality (AR) and virtual reality (VR), the weapon is oriented relative to the trainee's HMD and is determined with electronic instrumentation of that weapon.

### SUMMARY

In one embodiment, systems and methods for determining a spatial orientation of a weapon in an augmented reality training environment are disclosed. Fiducial markers are mounted on the weapon and two cameras are mounted on a user's head to capture spatial coordinates of the plurality of fiducial markers. The spatial coordinates of fiducial markers are processed to determine the spatial orientation of the weapon and/or detect any movement indicative of a simulated discharging of the weapon. Augmented reality imagery is generated based on the spatial orientation and the detected movement. The augmented reality imagery corresponding to the spatial orientation and discharging of the weapon is rendered for the user with the head-mounted display.

In another embodiment, the disclosure provides a system for determining a spatial orientation of a weapon in a head-relative coordinate system. The system includes at least one processor and a plurality of fiducial markers configured to be mounted on the weapon. The system further includes at least two sensors communicably coupled to the at least one processor. The at least two sensors are configured to be mounted on a user's head to:

capture spatial coordinates of each of the plurality of fiducial markers; and

the spatial coordinates to the at least one processor.

The system further includes an attachment unit configured to attach the at least two sensors to a head-mounted display. The at least one processor is configured to:

receive the spatial coordinates of each of the plurality of fiducial markers from the at least two sensors;

process the spatial coordinates to determine the spatial orientation of the weapon; detect a discharging of the weapon;

generate augmented reality imagery based on the spatial orientation and the detected movement; and

transmit the augmented reality imagery corresponding to the spatial orientation and discharging of the weapon to the head-mounted display.

In another embodiment, a method for determining a spatial orientation of a weapon in a head-relative coordinate system. The spatial coordinates of a plurality of fiducial markers mounted on the weapon are captured. The spatial coordinates are transmitted to the at least one processor. The spatial coordinates of each of the plurality of fiducial markers are received by the at least one processor from the at least two sensors. The spatial coordinates are processed to determine the spatial orientation of the weapon. A discharging of the weapon is detected. The augmented reality imagery is generated based on the spatial orientation and the detected movement. The augmented reality imagery corresponding to the spatial orientation and discharging of the weapon is transmitted to the head-mounted display.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1A illustrates a block diagram showing an embodiment of a weapon orientation determination system according to an embodiment of the present disclosure;

FIG. 1B illustrates a block diagram showing an embodiment of a weapon orientation determination system according to another embodiment of the present disclosure;

FIG. 2 illustrates a schematic view of a weapon in combination with at least one system as described in FIGS. 1A and 1B;

FIG. 3 illustrates a perspective view of a sensor device of the system as described in FIGS. 1A and 1B;

FIG. 4 illustrates a side view of a weapon according to an embodiment of the present disclosure;

FIG. 5 illustrates a top view of the weapon depicted in FIG. 4.

FIG. 6A illustrates a back view of a weapon according to an embodiment of the present disclosure;

FIG. 6B illustrates a side view of the weapon depicted in FIG. 6A;

FIG. 7 illustrates a method for determining a spatial orientation of a weapon in a head-relative coordinate system according to an embodiment of the present disclosure;

FIG. 8 illustrates a method for determining a spatial orientation of a weapon in a head-relative coordinate system according to another embodiment of the present disclosure; and

FIG. 9 illustrates a method for determining a spatial orientation of a weapon in a head-relative coordinate system according to another embodiment of the present disclosure.

In the appended figures, similar components and/or features may have the same reference label. Further, various components of the same type may be distinguished by following the reference label by a second alphabetical label that distinguishes among the similar components. If only the first reference label is used in the specification, the description applies to any one of the similar components having the same first reference label irrespective of the second reference label.

### DETAILED DESCRIPTION

Below we provide preferred exemplary embodiment(s) only, and are not intended to limit the scope, applicability or configuration of the disclosure. Rather, preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Embodiments described herein are generally related to a system and method for determining a spatial orientation of a weapon in a head-relative coordinate system. In particular, some embodiments of the disclosure incorporate one or more arrangements with respect to orientation tracking elements configured in combination with different types of weapons. The weapons used herein may be simulator weapons capable of functioning in a weapon simulating environment. The disclosure specifically indicates the usage of one or more active or passive markers or fiducial markers. The active or passive markers are placed on the weapon according to the pre-calibrated pattern. One or more camera sensors also form a part of the disclosure, which are configured to track one or more active or passive markers. The tracking of one or more active or passive markers leads to a calculation of spatial coordinates of the one or more active or passive markers according to six-degree-of-freedom (6-DoF) transformation. This calculation further leads to the determination of the orientation of the weapon with respect to the head of the user. The resulting weapon orientation is further transmitted to a display device, in particular, a head-mounted display device. The head-mounted display device is worn by the user.

The detection and presentation of the weapon orientation on the head-mounted display device help a user, in particular, a trainee soldier to train in the weapon simulating environment and perform target practice in an augmented real-world scenario. Such arrangements create the augmented real-world scenario without the requirement of any external truss and camera systems. Furthermore, such arrangements enable the trainee soldier at any time or place of convenience without actually visiting any training centers. The augmented real-world scenario also provides other information, such as the ballistic profile on the head-mounted display device.

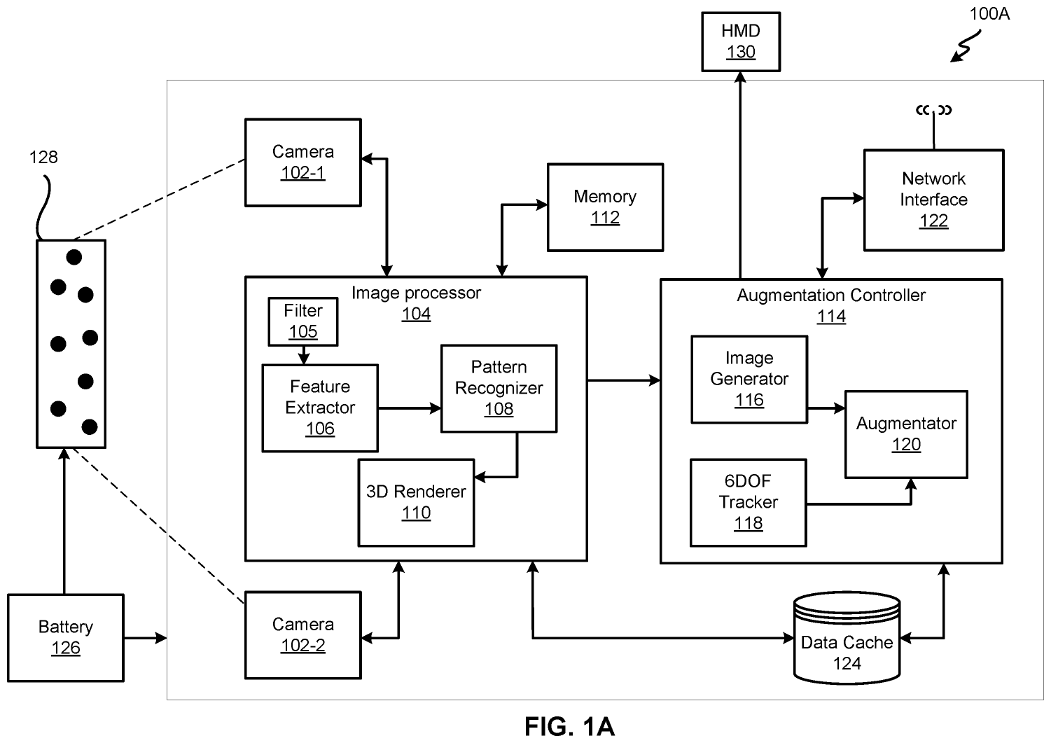

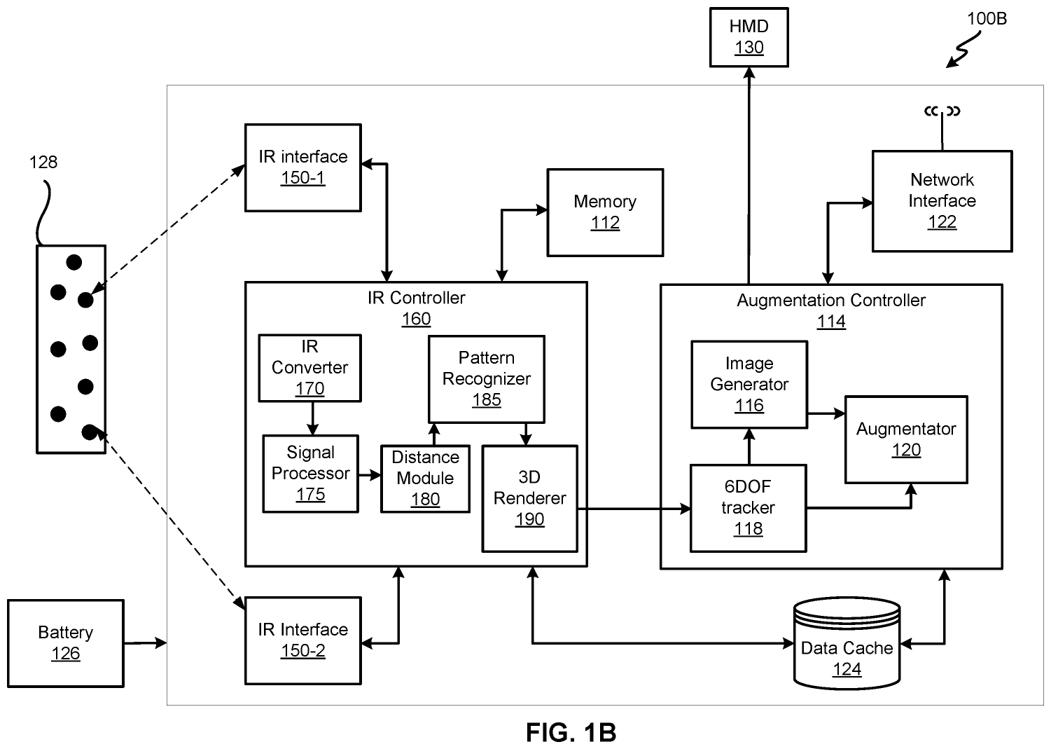

Referring to FIG. 1A illustrates a system 100A for determining a spatial orientation of a weapon in a head-relative coordinate system. The system 100A includes two cameras 102-1, 102-2, an image processor 104, a filter 105, a feature extractor 106, a pattern recognizer 108, a 3D 110, a memory 112, an augmentation controller 114, an image generator 116, a six-degrees-of-freedom (6-DoF) tracker 118, an augmentator 120, a network interface 122, a data cache 124, a battery 126, and a plurality of fiducial markers 128.

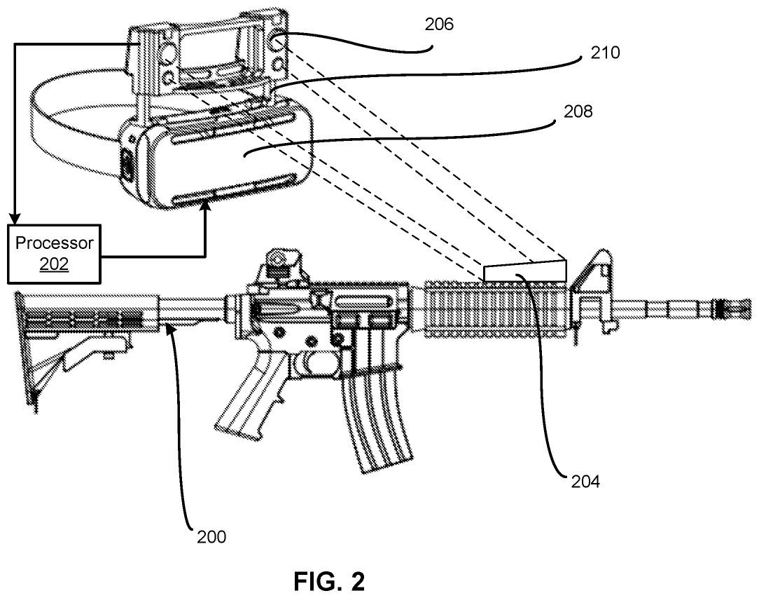

The system 100A is powered by the battery 126. In some embodiments, the system 100A may utilize a different power source, such as a wired power supply from the training centers. Specifically, in the embodiment of FIG. 1A, two cameras (interchangeably referred to as “the cameras”) 102-1 and 102-2 are configured to capture one or more images of the weapon (will be later depicted in FIG. 2). However, the number of cameras may be increased or decreased as per the application attributes. The cameras 102-1 and 102-2 may also capture the surrounding environment of the weapon and/or the user. Primarily, the cameras 102-1 and 102-2 are configured to capture the images of the plurality of fiducial markers 128, which are strategically placed upon the weapon according to a pre-calibrate pattern. In some embodiments, the plurality of fiducial markers is a group of light-emitting diodes mounted on at least a portion of the weapon in a pre-calibrated pattern. The pre-calibrated pattern may be indicative of a default position and orientation of the weapon. A change in the position of the plurality of fiducial markers 128 may indicate a change in the pre-calibrated pattern. The cameras 102-1 and 102-2 may be configured to record the change in the pre-calibrated pattern. The cameras 102-1 and 102-2 are communicably coupled to at least one processor, particularly the image processor 104. In general, the cameras include a combination of lenses and mirrors strategically placed to capture an image or record one or more video frames (“one or more images” hereinafter). However, for further analysis of one or more images, cameras 102-1 and 102-2 may forward one or more images to the image processor 104.

The image processor 104 may be configured to perform image processing, and the image processor may be any one of the foregoing other processors. The image processing includes image processing operations such as demosaicing, automatic exposure, automatic white balance, auto-focus, sharpening enhancement, and noise reduction performed on the image data. Noise reduction operations performed on interference noise of an image, including spatial noise reduction, temporal noise reduction, or the like. Optionally, image processing may further include storage of image data or video data that is present in a processing process. The cameras 102 can be black and white, color or use other spectra to capture the fiducial markers.

The image processor 104 comprises the filter 105, particularly an image filter. The image filter may refer to an image preprocessing parameter set preset. Specifically in the embodiment of FIG. 1A, filter 105 is configured to perform suppression of the interference noise of the image, including spatial noise reduction, temporal noise reduction, and image noise. Filter 105 may forward the filtered image toward the feature extractor 106.

The feature extractor 106 may be configured to identify and extract relevant features from an image. The feature extractor 106 may be configured to receive content from the image processor to identify and extract the relevant features. The feature extractor 106 may include instructions to perform text recognition, audio recognition, object recognition, pattern recognition, face recognition, etc. The feature extractor 106 may also be configured to perform feature extraction periodically, for example, the feature extractor 106 may be configured to perform feature extraction from a real-time recorded video at a time interval of (PP Term) 30 seconds.

Specifically in the embodiment of FIG. 1A, the feature extractor 106 may be configured to extract the features of the filtered forwarded herein by filter 105. The feature extractor 106 may include instructions to perform the identification and extraction of a plurality of fiducial markers 128. Furthermore, the feature extractor 106 may include instructions to perform identification and extraction of the plurality of fiducial markers 128 periodically. The periodic identification and extraction of the plurality of fiducial markers 128 may assist in determining a change in the pre-calibrated pattern of the plurality of fiducial markers 128. Information pertaining to the recognition of the plurality of fiducial markers 128 is transmitted to the pattern recognizer 108.

The pattern recognizer 108 may include instructions to perform recognition of a pattern associated with the plurality of fiducial markers 128 in order to identify the position and orientation of the weapon. Information associated with the position and orientation of the weapon may be transmitted to the 3D renderer 110. In some embodiments, the 3D renderer may be implemented as an application to convert multiple images or video frames along with intrinsic and extrinsic data to create a 3D model. Specifically, in the embodiment of FIG. 1A, the 3D renderer may receive one or more images captured by the cameras 102-1, 102-2 along with the intrinsic and extrinsic data, particularly the information associated with the position and orientation of the weapon computed based on the pattern recognized by the pattern recognizer 108. Further, the 3D renderer 110 may utilize one or more images and the information associated with the position and orientation of the weapon to create a 3D model of the surrounding environment and include a 3D depiction of the weapon oriented according to spatial coordinates corresponding to the position and orientation of the weapon in a real-world scenario. The system 100A also incorporates data cache 124, which is communicably coupled to the image processor 104 and the augmentation controller 114 to enable easy access to data while computation of the spatial coordinates.

In some embodiments, the augmentation controller 114 along with the (6-Dof) tracker 118 and other related components may be installed internally to the head-mounted display (HMD) 130. However, in the embodiment of FIG. 1A, the augmentation controller 114 has been depicted as an external element to bring more clarity in understanding the functioning of the augmentation controller 114. The 6-DoF refers to the freedom of movement of a rigid body (e.g., a weapon) in a three-dimensional space. In general, the augmentation controller 114 has the ability to track rotational and translational movements of the augmented controller 114, where the augmented controller 114 is mounted on the head of the user, in other words, the augmentation controller 114 may then be able to generate an augmented reality with respect to the head of the user. In continuation to the above, after the generation of a 3D model, the image processor 104 may further forward the 3D model to the augmentation controller 114. The augmentation controller 114 may feed information pertaining to the 3D model generated by the 3D renderer 110 to the 6-DoF tracker 118. The image processor 104 simultaneously sends imaging data to the image processor 104, which is further forwarded to the augmentator 120. The augmentator 120 generates augmented reality imagery, which is further transmitted to the head-mounted display (HMD) 130 via the augmentation controller 114. In an example, the HMD 130 is a Microsoft™ HoloLens™. The augmentation controller 114 may further forward the augmented reality imagery to the network interface 122, which enables communication of the system 100A with one or more users training in a similar environment or to a central server.

Referring to FIG. 1B, illustrates a system 100B for determining a spatial orientation of the weapon in a head-relative coordinate system according to another embodiment of the present disclosure. The system 100B includes two IR interfaces 150-1, 150-2, an IR controller 160, an IR converter 170, a signal processor 175, a distance module 180, a pattern recognizer 185, a three-dimensional renderer 190, the memory 112, the augmentation controller 114, the image generator 116, the 6-DoF tracker 118, the augmentator 120, the network interface 122, the data cache 124, the battery 126, and the plurality of fiducial markers 128.

The system 100B utilizes the IR interfaces 150-1, 150-2 to emit the IR radiation on the plurality of fiducial markers 128. In some embodiments wherein the plurality of fiducial markers is a group of infrared reflectors mounted on at least a portion of the weapon in a pre-calibrated pattern. Further the IR radiation is reflected back to the IR interfaces 150-1, 150-2. In some embodiments, light IR interfaces 150-1, 150-2 may utilize LED based emitters. In some other embodiments, light IR interfaces 150-1, 150-2 may utilize laser-based emitters. Specifically in the embodiment of FIG. 1B, two IR interfaces (interchangeably referred to as “the IR interfaces”) 150-1 and 150-2 are configured to transmit and receive the reflected IR radiation from the plurality of fiducial markers 128. However, the number of IR interfaces may be increased or decreased as per the application attributes. The IR interfaces 150-1, 150-2 may be configured to record the change in the in the pre-calibrated pattern. In an example, the pre-calibrated pattern may refer to a default distance maintained each of the plurality of fiducial markers 128 with respect to the IR interfaces 150-1, 150-2, particularly infrared reflectors mounted on the weapon. The IR interfaces 150-1, 150-2 are communicably coupled to the IR controller 160.

The IR controller 160 includes the IR converter that may convert the reflected IR radiation into electrical signals. The electrical signals may be further processed by the signal processor 175 in order to determine the signal intensity. Using stereoscopy, the location of the fiducial markers 128 in a three-dimensional space is determined from the two IR interfaces 150. The information relative to the change in distance may be forwarded to the pattern recognizer to determine the pattern of IR reflectors, which may be utilized by the 3D renderer 190 to create a 3D model as described in FIG. 1A. Similar to FIG. 1A the 3D model is used by the augmentation controller 114 to generate the augmented reality imagery, which is further transmitted to the HMD 130 via the augmentation controller 114. The augmentation controller 114 may further forward the augmented reality imagery to the network interface 122.

Referring to FIG. 2 illustrates a weapon 200 in combination with system 100 as described in FIGS. 1A and 1B. The system is combined with various elements of FIG. 1A and FIG. 1B. The processor 202 is coupled to the HMD 208. The system 100 comprises a plurality of fiducial markers 204 configured to be mounted on the weapon 200. Two sensors 206 are communicably coupled to the processor 202. The two sensors 206 are configured to be mounted on a user's head to capture spatial coordinates of each of the plurality of fiducial markers and transmit the spatial coordinates to the processor 202.

In some embodiments, the sensors 206 are a set of two cameras configured to be mounted on a user's head or HMD 208 as shown here, and the sensors 206 are spaced apart from each other to provide a binocular view for stereoscopic analysis. In an example, the sensors are spaced apart in the range of 7 to 9 inches from each other. In some embodiments, the two sensors 206 are a set of infrared interfaces configured to be mounted on a user's head, and the two sensors 206 are spaced apart from each other. In some embodiments, the two sensors 206 are configured to be mounted on a user's head to capture a plurality of images of the surrounding environment of the user.

The system comprises an attachment unit 210 configured to attach the two sensors 206 to the HMD 208. The processor 202 is configured to receive the spatial coordinates of each of the plurality of fiducial markers 204 from the two sensors 206. Processor 202 is configured to process the spatial coordinates to determine the spatial orientation of weapon 200. In some embodiments, processor 202 is further configured to process the spatial coordinates by performing a 6-Dof coordinate transformation. The processor 202 is configured to detect movement indicative of a discharging of the weapon. The processor 202 is configured to generate augmented reality imagery based on the spatial orientation and the detected movement. The processor 202 is configured to transmit the augmented reality imagery corresponding to the spatial orientation and discharging of the weapon 200 to the head-mounted display. In some embodiments, the processor 202 is configured to perform Perspective-n-Point computations on the plurality of images received from at least two sensors to determine a head relative orientation of the weapon. In some embodiments, the processor 202 is configured to generate augmented reality imagery based on the head relative orientation of the weapon 200. In some embodiments, the processor 202 is configured to transmit the augmented reality imagery corresponding to the head relative orientation of the weapon 200 to the HMD 208. In some embodiments, the augmented reality imagery includes a virtual combat scene along with information corresponding to the position and orientation of the weapon, vision points of the user, and one or more ballistic profiles.

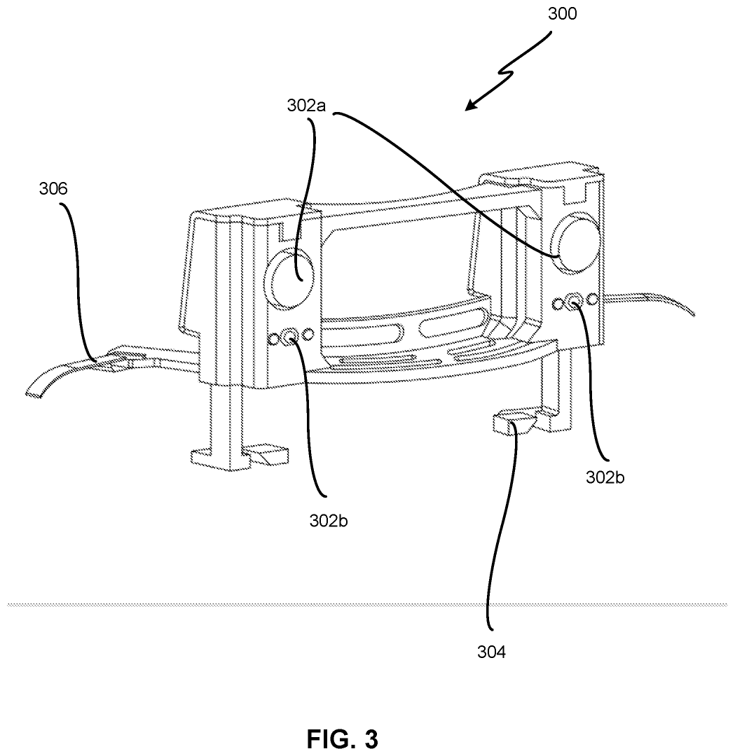

Referring to FIG. 3 illustrates a sensor device 300. The sensor device 300 includes at least two sensors 302, an attachment unit 304, and communication cables 306. The sensor device may be utilized in combination with the HMD. The attachment unit 304 may be configured to attach the sensor device 300 to the HMD. In some embodiments, the attachment unit is adjustable according to the size of the user's head. At least two sensors may be either of two camera sensors 302a or two IR interfaces 302b or maybe a combination of each of camera sensors 302a and two IR interfaces 302b. The communication cable 306 may be connectable with at least one processor or the HMD 130 in order to perform data transmission associated with the augmented reality imagery.

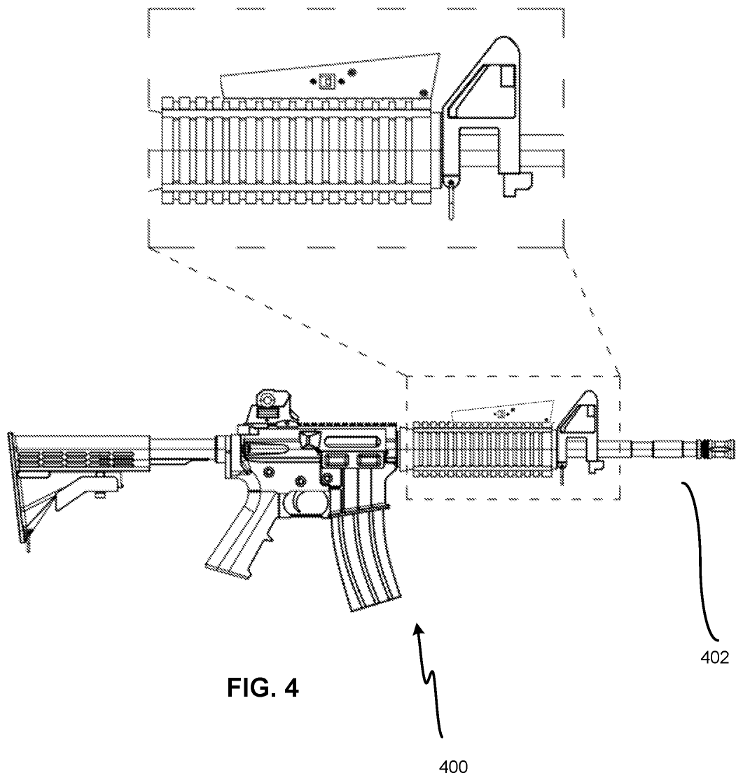

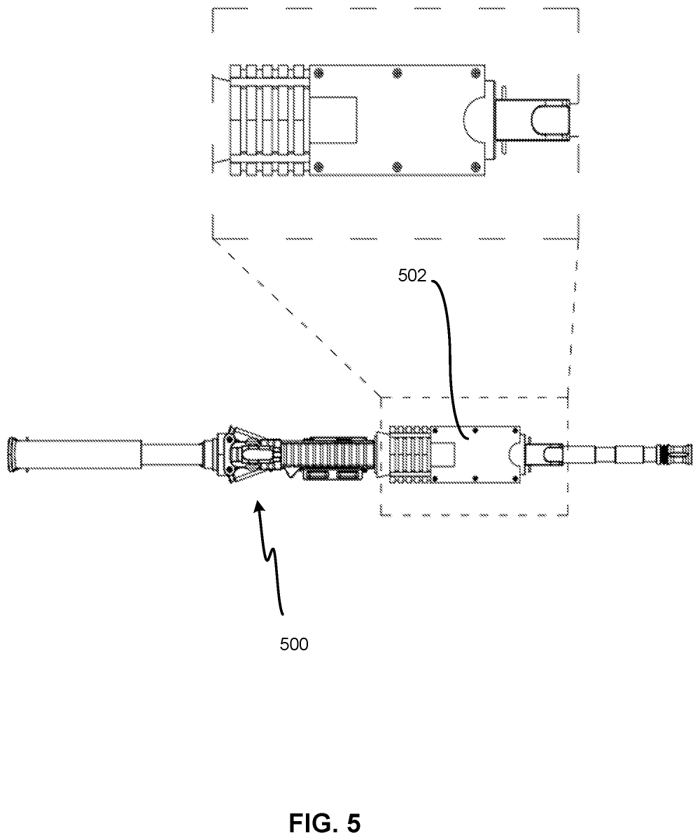

Referring to FIGS. 4 and 5, illustrates a weapon 400, 500 in a side view and top view respectively. The weapon 400, 500 in combination with the plurality of fiducial markers 402, 502 as described in FIGS. 1A and 1B. The plurality of fiducial markers 402, 502 are configured to be detachably mounted on the weapon 400, 500. In some embodiments, the plurality of fiducial markers 402, 502 are configured on a slider, which slide fits upon a front rail of the weapon 400, 500. In some embodiments, the plurality of fiducial markers 402 may be configured upon the weapon via a different a mechanism. To the extent that the fiducial markers 402 are movable with respect to the weapon 400, 500, a calibration can be performed to record their relative positioning on the weapon 400, 500.

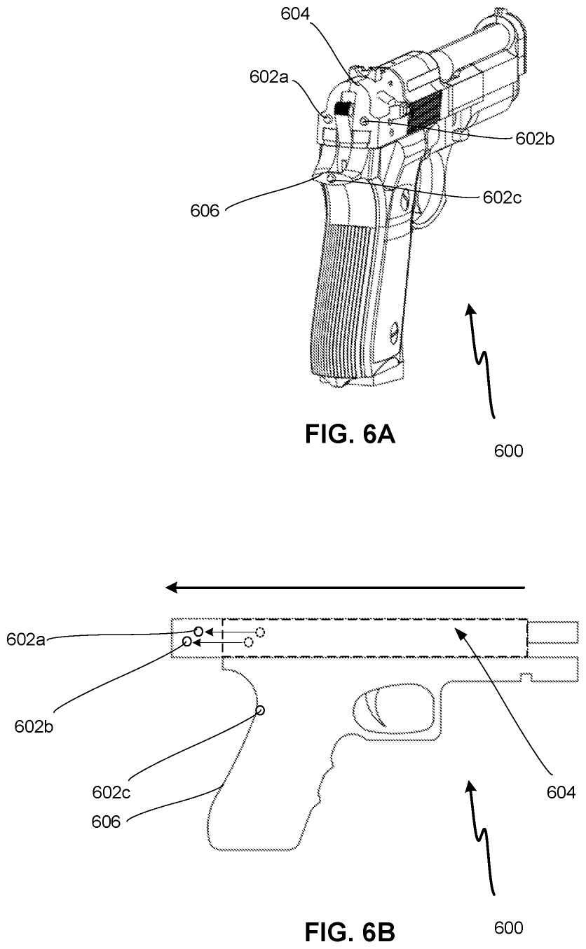

Referring to FIGS. 6A and 6B, illustrate a weapon 600 in a back view and side view respectively. The weapon 600 includes a number of fiducial markers 602 as described in FIGS. 1A and 1B. Specifically, in the embodiment of FIGS. 6A and 6B, IR reflectors are utilized as the plurality of fiducial markers 602. FIG. 6A depicts the weapon 600 that has not been discharged and that is provided with the plurality of fiducial markers 602 in a pre-calibrated pattern, in particular a triangular pattern. The triangular pattern is formed where two of the fiducial markers 602a, and 602b are placed on a slider 604 of the weapon 600, and one of the fiducial markers 602c is placed on a backstrap 606 of the weapon 600. Other embodiments could include more fiducial markers 602, for example on the trigger, hammer, etc.

FIG. 6B depicts the weapon 600, where the weapon 600 has been discharged by the pulling of a trigger. The weapon 600 in the action of discharging, reloads as the slider 604 goes back to the firing position. The sliding action of the slider 604 leads to a change in the pre-calibrated pattern. The pre-calibrated pattern being tracked by the combination of the IR interfaces and IR reflectors enables the processor to analyze a change in the pre-calibrated pattern to detect the movement indicative of the discharging of the weapon 600. As shown in FIG. 6B, a single arrow depicts the sliding action of the slider 604. Further two small arrows depict the change in the position of the two of the fiducial markers 602a, 602b placed on the slider 604. The change in the in the position of the two of the fiducial markers 602a, 602b with respect to the fiducial marker 602c placed on the backstrap 606 leads to the change in the pre-calibrated pattern that is recorded by the IR interfaces (not shown) and enables the detection of the discharging of the weapon. In an example, the detection of the movement indicative of the discharging of the weapon may provide information of indicative number of rounds left in a particular training event. The information may then be displayed on the HMD.

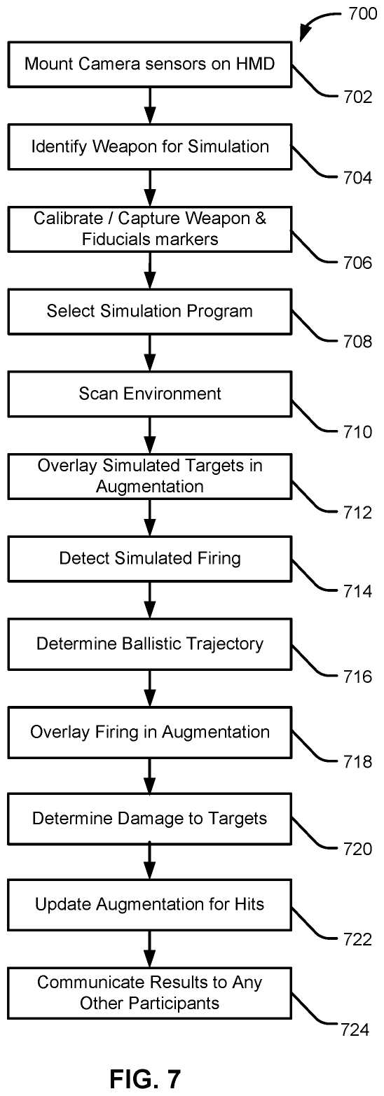

Referring to FIG. 7 illustrates a method 700 for determining a spatial orientation of a weapon in a head-relative coordinate system according to an embodiment of the present disclosure. Some steps of method 700 may be performed by the systems 100A, and 100B and by utilizing processing resources through any suitable hardware, software, or a combination thereof.

At block 702, the at least two sensors are mounted on the HMD by using an attachment unit (Referring to FIG. 3) The attachment unit may be configured to attach the sensors to the HMD.

At block 704, a weapon is identified, on which the simulation is to be performed. For example, different users may have different weapons on which training may be required. Different weapons may have different simulation profiles.

At block 706, the weapon and the associated fiducial markers may be calibrated with respect to the different simulation profiles. Pre-programmed models for different weapons may already be in the software for selection by the user. Prevailing templates can be used to apply the fiducial markers to a service weapon of the user so that they are placed in known locations to the software. Where a template is not used or for greater accuracy, calibration by scanning the weapon from different angles can be done to capture the weapon and its fiducial markers being done in some embodiments.

At block 708, a simulation program designed for the selected weapon is selected, where the simulation program may correspond to the simulation profile associated with the selected weapon. The simulation program may enable different types of simulation modes or weapons with respect to the selected.

At block 710, the surrounding environment of the user may be scanned by the camera sensors (referring to FIG. 2), where the camera sensors are configured to be mounted on a user's head to capture a plurality of images of a surrounding environment of the user.

At block 712, simulated targets are overlayed in augmentation that may be captured by the camera sensors and controlled by the augmentation controller 114 of FIG. 1.

At block 714, at least one processor may detect the simulated firing upon determining the discharging of the weapon (referring to FIG. 6). The discharging of the weapon may provide information on an indicative number of rounds left in a particular training event. The information may then be displayed on the HMD (referring to FIG. 6).

At block 716, the ballistic trajectory/profiles are determined by at least one processor in order to relay the same information on the HMD. The ballistic trajectory/profiles may enable the user to calibrate the weapon in a specific way. For example, a sniper may use them to learn about windage and other factors during a target shooting practice session at a larger distance.

At block 718, at least one processor overlays firing images determining the discharging of the weapon. The firing images may provide the user with some additional information related to after effects of shooting that ensures better psychological preparation in the real-world scenario.

At block 720, the damage to the targets is determined by at least one processor in order to relay the same information on the HMD. The information related to the damage to targets enables one to learn a shooting pattern for different shooting scenarios.

At block 722, the augmented reality imagery may be updated in order to train for the next round of firing.

At block 724, the augmentation controller 114 may further forward the augmented reality imagery to the network interface 122, which enables communication of the system 100A with one or more users training in a similar environment or to a central server (referring to FIG. 1A).

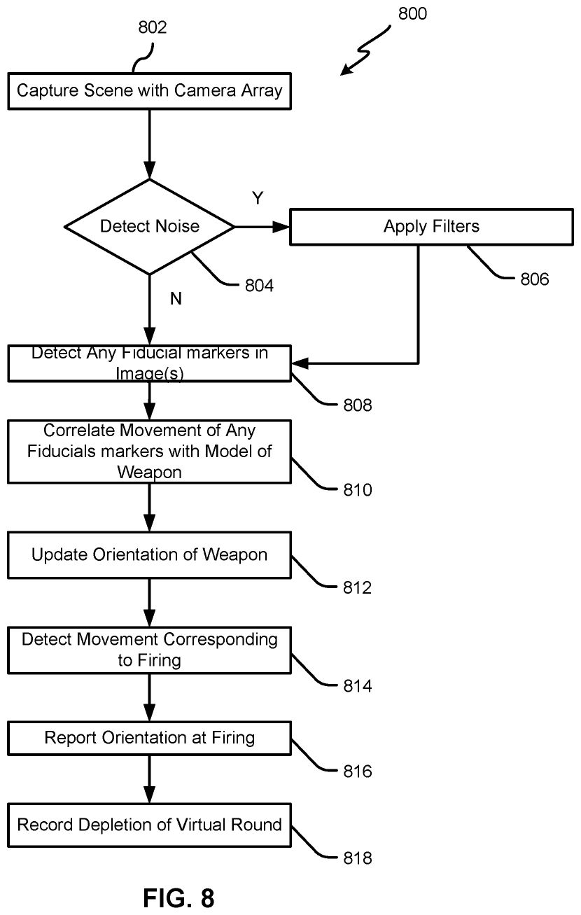

Referring to FIG. 8 illustrates method 800 for determining a spatial orientation of a weapon in a head-relative coordinate system according to an embodiment of the present disclosure. Some steps of method 800 may be performed by the systems 100A, and 100B and by utilizing processing resources through any suitable hardware, non-transitory machine-readable medium, or a combination thereof.

At block 802, the surrounding environment of the user may be scanned by the camera sensors (referring to FIG. 2), where the camera sensors are configured to be mounted on a user's head to capture a plurality of images of a surrounding environment of the user.

At block 804, a noise may be detected by the image processor 104 (referring to FIG. 1A) in one or more images of the surrounding environment scanned by the camera sensors.

At block 806, filter 105 is configured to perform suppression of the interference noise of the image, including spatial noise reduction, temporal noise reduction, and image noise (referring to FIG. 1A).

At block 808, the feature extractor 106 may include instructions to perform identification and extraction of the plurality of fiducial markers 128 (referring to FIG. 1A).

At block 810, a movement of the plurality of fiducial markers is correlated with a model of the weapon, where the correlation may correspond to the pattern recognized by the pattern recognizer (Referring to FIGS. 1A and 1B).

At block 812, the orientation of the weapon is updated based on the pattern recognized by the pattern recognizer.

At block 814, a movement corresponding to the firing is detected by at least one processor. For example, the weapon may change its position and orientation due to the recoil generated in the weapon or movement of the slide or other mechanisms because of the discharging of the weapon. Some embodiments use an electronic trigger sensor to detect the firing of the weapon instead of movement detection.

At block 816, the orientation of the weapon just before the firing of the weapon is determined and reported in the form of information overlayed in the augmented reality imagery.

At block 818, the detection of the discharging of the weapon (e.g., through movement of the slide and/or a trigger sensor) may provide information on an indicative number of rounds left in a particular training event. The information may then be displayed on the HMD (referring to FIG. 6).

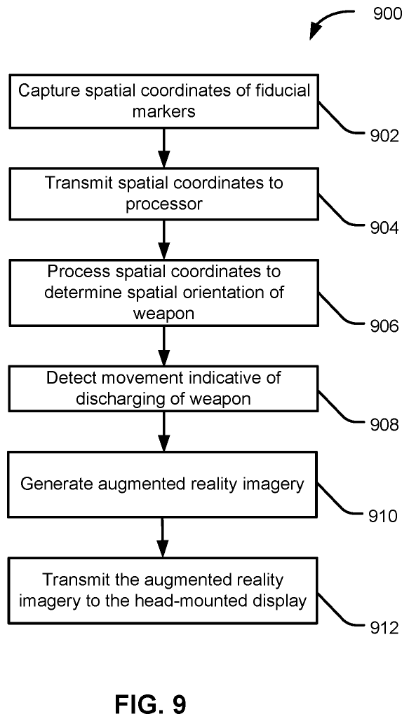

Referring to FIG. 9 illustrates method 800 for determining a spatial orientation of a weapon in a head-relative coordinate system according to another embodiment of the present disclosure. Some steps of method 900 may be performed by the systems 100A, and 100B and by utilizing processing resources through any suitable hardware, non-transitory machine-readable medium, or a combination thereof.

At block 902, the spatial coordinates of a plurality of fiducial markers mounted on the weapon are captured.

At block 904, the spatial coordinates are transmitted to at least one processor.

At block 906, the spatial coordinates are processed to determine the spatial orientation of the weapon.

At block 908, the movement indicative of a discharging of the weapon is determined.

At block 910, the augmented reality imagery based on the spatial orientation and the detected movement is generated.

At block 912, the augmented reality imagery corresponding to the spatial orientation and discharging of the weapon is transmitted to the head-mounted display.

Such methods and systems may help build a training environment for one or more users to train either alone or in parallel. Such a training environment may prevent the need for mounting external training equipment. In this manner, target hitting practice can be performed in a virtual environment including augmented details suited for target hitting. Further, the methods and systems may ensure achieving a target-hitting accuracy in the range of 0.5 milliradians to 1.5 milliradians.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail to avoid obscuring the embodiments.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art. While the principles of the disclosure have been described above in connection with specific apparatuses and methods, it is to be clearly understood that this description is made only by way of example and not as limitation on the scope of the disclosure.

What is claimed is:

1. A system for determining a spatial orientation of a weapon in a head-relative coordinate system, the system comprising:
at least one processor;
a plurality of fiducial markers configured to be mounted on the weapon;
at least two sensors communicably coupled to the at least one processor, wherein the at least two sensors are configured to be mounted on a user's head to:
capture spatial coordinates of each of the plurality of fiducial markers; and
transmit the spatial coordinates to the at least one processor; and
an attachment unit configured to attach the at least two sensors to a head-mounted display;
wherein the at least one processor is configured to:
receive the spatial coordinates of each of the plurality of fiducial markers from the at least two sensors;
process the spatial coordinates to determine the spatial orientation of the weapon;
detect a discharging of the weapon;
generate augmented reality imagery based on the spatial orientation and the detected discharge; and
transmit the augmented reality imagery corresponding to the spatial orientation and discharging of the weapon to the head-mounted display.

2. The system for determining the spatial orientation of the weapon in the head-relative coordinate system as recited in claim 1, wherein the plurality of fiducial markers is a group of light-emitting diodes mounted on at least a portion of the weapon in a pre-calibrated pattern.

3. The system for determining the spatial orientation of the weapon in the head-relative coordinate system as recited in claim 1, wherein the plurality of fiducial markers is a group of infrared reflectors mounted on at least a portion of the weapon in a pre-calibrated pattern.

4. The system for determining the spatial orientation of the weapon in the head-relative coordinate system as recited in claim 1, wherein the at least two sensors are a set of two cameras configured to be mounted on a user's head, and wherein the at least two sensors are spaced apart from each other.

5. The system for determining the spatial orientation of the weapon in the head-relative coordinate system as recited in claim 1, wherein the at least two sensors are a set of infrared interfaces configured to be mounted on a user's head, and wherein the at least two sensors are spaced apart from each other.

6. The system for determining the spatial orientation of the weapon in the head-relative coordinate system as recited in claim 1, wherein the at least one processor is further configured to process the spatial coordinates by performing a six-degrees-of-freedom (6-DoF) coordinate transformation.

7. The system for the spatial orientation of the weapon in the head-relative coordinate system as recited in claim 1, wherein the attachment unit is adjustable according to the size of the user's head.

8. The system for determining the spatial orientation of the weapon in the head-relative coordinate system as recited in claim 3, wherein the at least one processor is configured to analyze a change in the pre-calibrated pattern to detect movement indicative of the discharging of the weapon.

9. The system for determining the spatial orientation of the weapon in the head-relative coordinate system as recited in claim 1, wherein the at least two sensors are configured to be mounted on a user's head to:
capture a plurality of images of a surrounding environment of a user;
perform Perspective-n-Point computations on the plurality of images received from at least two sensors to determine a head relative orientation of the weapon;
generate augmented reality imagery based on the head relative orientation of the weapon; and
transmit the augmented reality imagery corresponding to the head relative orientation of the weapon to the head-mounted display.

10. The system for determining the spatial orientation of the weapon in the head-relative coordinate system as recited in claim 1, wherein the augmented reality imagery includes a virtual combat scene along with information corresponding to a position and orientation of the weapon, a vision point of a user, and one or more ballistic profiles.

11. A method for determining a spatial orientation of a weapon in a head-relative coordinate system, the method comprising:
capturing spatial coordinates of a plurality of fiducial markers mounted on the weapon;
transmitting the spatial coordinates to at least one processor;
receiving the spatial coordinates of each of the plurality of fiducial markers from at least two sensors;
processing the spatial coordinates to determine the spatial orientation of the weapon;
detecting a discharging of the weapon;
generating augmented reality imagery based on the spatial orientation; and
transmitting the augmented reality imagery corresponding to the spatial orientation and discharging of the weapon to a head-mounted display.

12. The method for determining the spatial orientation of the weapon in the head-relative coordinate system as recited in claim 11, wherein the plurality of fiducial markers is a group of light-emitting diodes mounted on at least a portion of the weapon in a pre-calibrated pattern.

13. The method for determining the spatial orientation of the weapon in the head-relative coordinate system as recited in claim 11, wherein the plurality of fiducial markers is a group of infrared reflectors mounted on at least a portion of the weapon in a pre-calibrated pattern.

14. The method for determining the spatial orientation of the weapon in the head-relative coordinate system as recited in claim 11, wherein the at least two sensors are a set of two cameras configured to be mounted on a user's head, and wherein the at least two sensors are spaced apart from each other.

15. The method for determining the spatial orientation of the weapon in the head-relative coordinate system as recited in claim 11, wherein the at least two sensors are a set of infrared interfaces configured to be mounted on a user's head, and wherein the at least two sensors are spaced apart from each other.

16. The method for determining the spatial orientation of the weapon in the head-relative coordinate system as recited in claim 11, wherein the method further comprises processing the spatial coordinates by performing a six-degrees-of-freedom (6-DoF) coordinate transformation.

17. The method for determining the spatial orientation of the weapon in the head-relative coordinate system as recited in claim 13, wherein the method further comprises analyzing a change in the pre-calibrated pattern to detect movement indicative of the discharging of the weapon.

18. The method for determining the spatial orientation of the weapon in the head-relative coordinate system as recited in claim 11, wherein the method further comprises:
capturing a plurality of images of a surrounding environment of a user;
performing Perspective-n-Point computations on the plurality of images received from the at least two sensors to determine a head relative orientation of the weapon;
generating augmented reality imagery based on the head relative orientation of the weapon; and
transmitting the augmented reality imagery corresponding to the head relative orientation of the weapon to the head-mounted display.

19. The method for determining the spatial orientation of the weapon in the head-relative coordinate system as recited in claim 11, wherein the augmented reality imagery includes a virtual combat scene along with information corresponding to a position and orientation of the weapon, a vision point of a user, and one or more ballistic profiles.
